(19) United States
(12) Patent Application Publication
(10) Pub. No.: US 2007/0066316 A1
(43) Pub. Date: Mar. 22, 2007

(54) Multi-channel Internet protocol smart devices

(76) Inventor: Thomas R. Hoover, Troutville, VA (US)

Correspondence Address: SETO PATENTS, 406 RIVERLAND DR., SALEM, VA, 24153, US

(21) Appl. No.: 11/524,123

(22) Filed: Sep. 20, 2006

Related U.S. Application Data
(60) Provisional application No. 60/718,826, filed on Sep. 20, 2005.

(51) Int. Cl. H04B 1/38; H04Q 7/20

(52) U.S. Cl. 455/445; 455/517

(57) ABSTRACT

A communications smart device that can be added to an existing network and immediately start monitoring the network for communication information. Each smart device includes at least one output means, such as a speaker or a display screen. When information destined for the smart device is recognized, the smart device extracts the communication information and outputs the communication information via the device's output means. Multiple smart devices with speakers can be added to a company's existing local area network to provide a multi-zone paging system for the company. Alternatively, multiple smart devices with LED display screens can be added to a city's existing traffic monitoring network to provide traffic information to commuters. A telephone can be used as the input device for voice and a laptop computer can be used to input text and video. The present networked smart devices do not require a server to operate as intended.

### BACKGROUND OF THE INVENTION

The present invention was originally disclosed in U.S. provisional patent application Ser. No. 60/718,826 filed on Sep. 20, 2005, and priority is claimed to the provisional patent application.

The present invention relates generally to the field of communications and more specifically to flexible, multi-purpose communication devices that can easily be installed and networked together without the need of a server.

The Internet is a worldwide digital network and is made up of a large number of computer networks all linked together. Several million individual computers are connected through the computer networks. Anyone with access to one of the computers will have access to all of the other computers, in theory. TCP/IP (Transmission Control Protocol/Internet Protocol) is the set of rules that enables different types of computers and networks on the Internet to communicate with one another. TCP/IP was originally developed by the United States Department of Defense for computers using the UNIX operating system, but it is now used by every computer, regardless of operating system, on the Internet. TCP defines how data is transferred across the Internet to their destination. IP defines how data is divided into chunks, called packets, for transmission; it also determines the path each packet takes between computers. To be part of the Internet a computer, or other communication device, must have a unique Internet Protocol (IP) network address so that information can be correctly routed to and from the machine over the Internet.

Local Area Networks (LAN's) are collections of interconnected computers that can share data, applications, and resources, such as printers. Computers in a LAN are separated by distances of up to a few kilometers and are typically used in offices or across university campuses. A LAN enables the fast and effective transfer of information within a group of users and reduces operational costs. The most popular LAN protocol is called Ethernet, originally developed by Xerox in 1976, Ethernet is a widely implemented network from which the IEEE 802.3 standard for contention networks was developed. Ethernet uses a bus topology (configuration) and relies on the form of access known as CSMA/CD to regulate traffic on the bus. Network nodes are connected by coaxial cable (in either of two varieties, known as thin and thick) or by twisted-pair wiring. Thin Ethernet cabling is 5 millimeters (about 0.2 inch) in diameter and can connect network stations over a distance of 300 meters (about 1000 feet); thick Ethernet cabling is 1 centimeter (about 0.4 inch) in diameter and can connect stations up to 1000 meters (about 3300 feet) apart. Information on an Ethernet network is sent in variable-length frames containing delivery and control information plus up to 1500 bytes of data. The original Ethernet standard provides for baseband transmission at 10 megabits (10 million bits) per second. Most mid-size and large companies have LAN's in place within their current office buildings. Computers that are separated by greater distances can be connected together by a WAN (Wide Area Network). WAN's can be used to connect computers that are located in different cities or on different sides of the country.

### SUMMARY OF THE INVENTION

A smart communications device that is adapted for connection to a network, wherein after set-up the device can operate as a stand alone piece of equipment by monitoring information that is transmitted over the network, extracting desired information from the network and outputting the desired information for the benefit of an audience. The communications device comprises a processor, an amplifier, and an output means. The processor is assigned to monitor at least one channel of information that is transmitted over the network. In response to detecting information that is transmitted over the assigned channel, the processor processes the detected information and forwards the associated communication information. The amplifier is electrically connected to the processor and when the amplifier receives the communication information from the processor, the amplifier amplifies the communication information and forwards the amplified communication information. The output means is electrically connected to the amplifier and receives the amplified communication information from the amplifier. The output means then outputs the communication information so that the information can be heard or read by users in the area of the communications device.

Multiple channels of information can be transmitted over the network and the communications device can be assigned to monitor more than one channel at a time. In the preferred embodiment, the output means is a speaker and the speaker broadcasts the amplified communication information that it receives from the amplifier. The communications device also preferably includes a microphone that acts as a fail-safe device by listening to the information that is broadcast over the speaker and sending a failure message to an administrator when communication information is being broadcast but no sound is detected by the microphone.

The network can be an organization's existing network, including a LAN, a WAN, and a telephone network. Further, more than one smart communications device can be connected to the network. The multiple smart communications devices are initially set up on the network with the aid of a computer and the computer can subsequently be disconnected from the network. The communications devices are then able to operate independently and do not need a server to operate as intended.

The preferred network is an Ethernet that provides information and electrical power to the communications devices. However, the devices are adapted to accept a separate power source when other networks are used. The information sent to each communication device includes priority data and the priority data is used by the processor to determine an order of play for the communication information.

It is an object of the present invention to provide a multi-functional communication device that can easily be added to almost any existing network and subsequently operate independently to broadcast information to people in the vicinity of the device.

It is a further object of the present invention to provide a flexible paging system that can be used within a single building or within multiple buildings that are spread across the country.

It is yet another object of the present invention to provide an easy to install messaging system that displays pertinent text or video messages to the public at multiple locations.

### BRIEF DESCRIPTION OF THE DRAWINGS

The invention of the present application will now be described in more detail with reference to the accompanying drawings, given only by way of example, in which:

FIG. 1 is a schematic diagram of an exemplary smart device;

FIG. 2 shows multiple smart devices connected to a network;

FIG. 3 is a schematic diagram of an alternative smart device; and,

FIG. 4 shows the preferred format of digital information used by the present system.

### DETAILED DESCRIPTION OF THE INVENTION

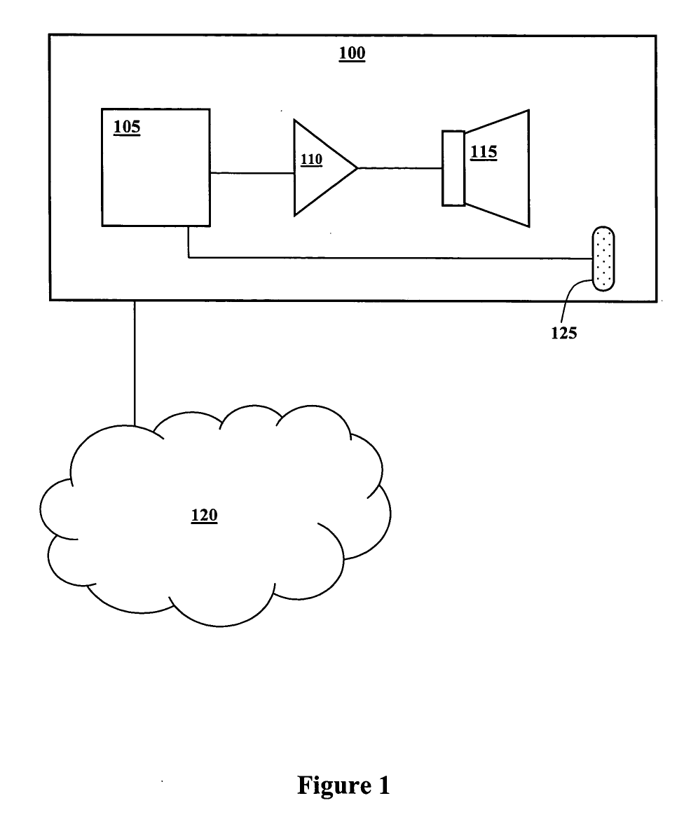

FIG. 1 shows an exemplary embodiment of the present multi-channel Internet Protocol (IP) smart device 100. Each IP smart device 100 includes an application specific processor 105 that enables the device to detect and process desired channels, or only a single channel, of information from multiple channels that are transmitted via network 120. Once the processor 105 detects desired information, it extracts the data to be output, such as an audio signal, and sends the data to amplifier 110. Amplifier 110 amplifies the audio signal, in this example, and sends the amplified signal to speaker 115. Speaker 115 then broadcasts the audio signal into the area in which the IP smart device 100 is located. IP smart device 100 can be as small in size as a small traditional speaker, and therefore can be hung on a wall or in the ceiling. Power for the IP smart device 100 is provided through the same wire, or cable, that sends the data to the smart device, in the preferred embodiment. Thus, there is no need to worry about providing separate power supplies for each device. The IP smart device 100 is also capable of detecting a failure in speaker 115. Microphone 125 is used to monitor the output of the speaker 115. When the speaker 115 should be playing an audio signal and no sound is picked up by microphone 125 a failure signal is sent to a system administrator alerting them to a problem with the IP smart device 100.

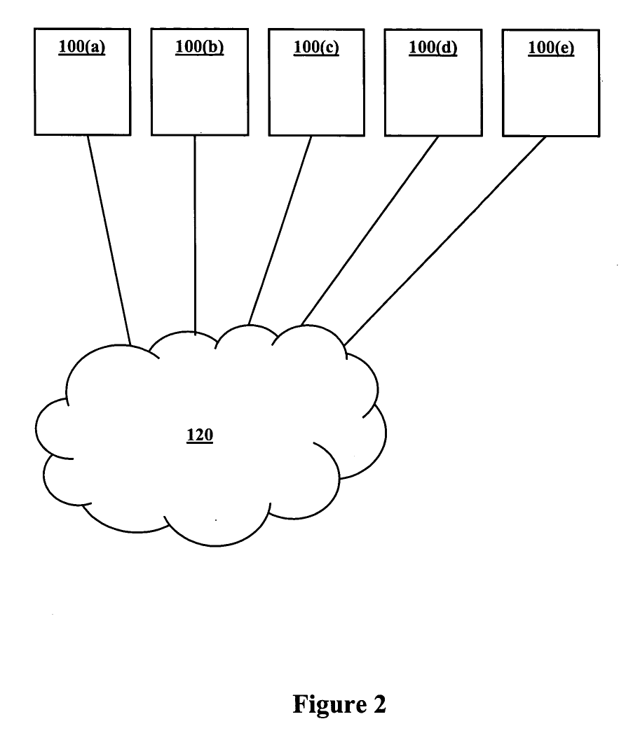

FIG. 2 shows a system wherein five IP smart devices 100(a)-(e) are connected to the network 120. Each IP smart device 100(a)-(e) can be located on the same floor of a building, different floors of a building, or distributed among multiple buildings. Each IP smart device 100(a)-(e) in FIG. 2 includes the hardware and functionality of the IP smart device 100 shown in FIG. 1. Thus, each of the five IP smart devices 100(a)-(e) receives power and data from a single wire, or cable, and each device is able to detect failure of the device's output device or speaker in the preferred embodiment. The processor in each IP smart device 100(a)-(e) can be programmed to detect and play selected channels, or just a single channel, of information. In an exemplary embodiment, five channels are transmitted to each smart device 100(a)-(e) via network 120. Each smart device 100(a)-(e) is preset to listen to one or more of the five channels. The smart devices “listen” to their preset channels, extract any information that is sent over their channel(s) then amplify and play the selected information over their output devices. When the output devices of the networked smart devices are speakers, the preferred input device for voice is a telephone. The system if preferably set up to allow a user to select one or more of the smart devices, by dialing between one and eleven digits on their telephone, and then have their voice broadcast over the speakers of the selected smart device(s). Almost any Windows® based computer can be used to setup and monitor the present smart devices. The computer can also be used play music over the smart devices, when pages are not being sent.

A beneficial feature of the present invention is that it can take advantage of an organization's infrastructure, specifically the pre-existing wiring. The present system can be tied into the organization's existing LAN, WAN or telephone lines. Exemplary uses of the present system include: a music and paging system for multiple floors in a single building; city wide paging system for all Fire & Rescue buildings; and, an interstate paging system between different branches of a national bank. When background music is being played over the present system, the music automatically mutes when a page is transmitted. An exemplary IP smart device has the following nominal specifications: an input impedance of 600 Ohms; an input level of −10 dBm; a voice switch sensitivity of −21 dBm; an output impedance of 50 Ohms; and, an output level of −10 dBm. The preferred protocol for the transmission of information is TCP/IP however, the following protocols may also be used: DHCP; IGMP v3; UDP; HTTP; Telnet; and, FTP. The preferred voice algorithm is G.711 (64 kbits/s) (ulaw), with echo suppression.

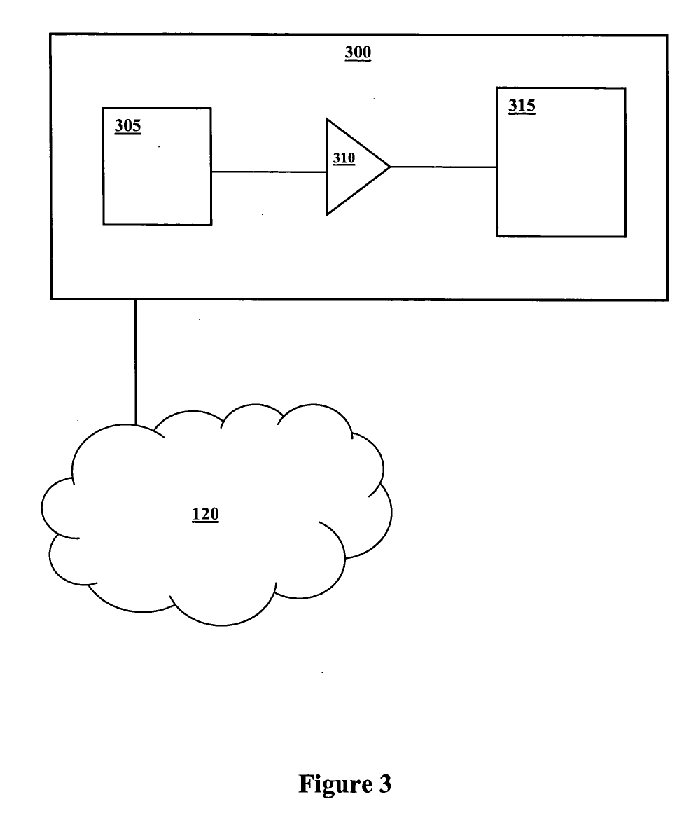

FIG. 3 shows an alternative embodiment 300 of the present IP smart device. In this embodiment, the IP smart device 300 uses a display screen 315 as the output device. Display screen 315 can be used to display video or text message information. This embodiment can be used indoors and outdoors as well, as a highway sign that gives information to motorists, for example. The display screen 315 can use any known display technology including light emitting diodes (LED), liquid crystal display (LCD), highway text boards, and others. Since the information transmitted to the present smart devices uses Internet Protocol, the devices can be distributed widely and connectivity problems are minimized. Further, since power and information are preferably provided to the devices over the same line the problem of power distribution is eliminated. In the preferred embodiment, the IP smart devices receive power over an Ethernet 802.3af compliant network. The remaining hardware in the IP smart device 300, the processor 305 and the amplifier 310, are similar to the hardware provided in the preferred embodiment shown in FIG. 1. Thus, multiple IP smart devices 300 can be added to a network and each device can be preset to “listen” to a selected channel, or multiple channels, of information transmitted over the network 120. A laptop computer can be used to set up the present smart devices and to add additional smart devices to the network. The laptop can also be used to transmit the text or video information that is to be displayed by each smart device.

In other alternative embodiments of the present system, the smart devices receive their electrical power from a source that is separate from the information network. These other embodiments are compatible with 25 or 70 volt amplifiers and include a 2.5 mm jack to receive the DC power. In all embodiments of the present invention, the IP smart devices can be initialized by an easy to use Windows® base setup, and a dedicated server is not required.

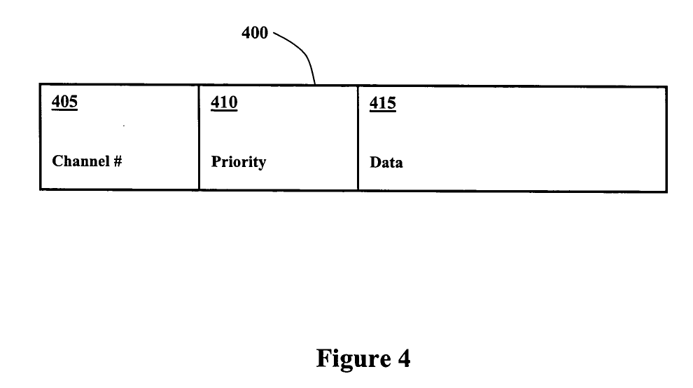

FIG. 4 shows the preferred format for transmitting information to the IP smart devices. Frame 400 includes at least three sections. Section 405 holds channel information that tells the smart devices which channel is being used to transmit the following information. By putting the channel information first, each smart device only needs to sample a small amount of data before it knows whether or not to continue to listen, or whether the device can ignore the remaining data in the frame 400. Section 410 holds priority data that tells appropriate smart devices the priority of the current information. A high priority can cause the smart device to pre-empt the signal that the device is currently outputting, and a low priority may allow for playing at the next available time slot. The last section 415 in the frame 400 holds the data that is to be played over the speaker or displayed on the display screen. The data section 415 is the largest section of the frame 400 and may contain thousands of bits, depending on the type of data being transmitted. Of course, the exact size of the frame and the sections will be dictated by the transmission protocol being used.

The foregoing description of the specific embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. A smart communications device that is adapted for connection to a network, wherein after set up the device can operate as a stand alone piece of equipment by monitoring information that is transmitted over the network, extracting desired information from the network and outputting the desired information, the communications device comprising:
a processor, wherein the processor is assigned to monitor at least one channel of information that is transmitted over the network and in response to detecting information that is transmitted over the assigned channel, processing the detected information and forwarding any communication information;
an amplifier that is electrically connected to the processor, wherein the amplifier receives the communication information from the processor, amplifies the communication information and forwards the amplified communication information; and,
an output means that is electrically connected to the amplifier, wherein the output means receives the amplified communication information from the amplifier and outputs the communication information so that the information can be understood by people in an area that is close to the communications device.

2. The device of claim 1, wherein multiple channels of information are transmitted over the network and the communications device is assigned more than one channel to monitor.

3. The device of claim 1, wherein the output means is a speaker and the speaker broadcasts the amplified communication information that it receives from the amplifier.

4. The device of claim 3, further comprising a microphone, wherein the microphone acts as a fail-safe device by listening to the communication information that is broadcast over the speaker and sending a failure message to an administrator when communication information is being broadcast but no sound is detected by the microphone.

5. The device of claim 1, wherein the network is an organization's existing network, including a LAN, a WAN, and a telephone network, and further wherein more than one smart communications device is connected to the network.

6. The device of claim 5, wherein the more than one smart communications devices are initially set up on the network with the aid of a computer that can later be disconnected from the network, and the communications devices do not need a server to operate as intended.

7. The device of claim 1, wherein the device also receives electrical power from the network.

8. The device of claim 1, wherein the detected information includes priority data and the priority data is used by the processor to determine an order of play of the communication information.

9. The device of claim 8, wherein the communication information can be voice data or music data and the voice data always has a priority that is higher than a priority of the music data.

10. The device of claim 1, wherein the device is able to operate on networks with different protocols including TCP/IP, DHCP, IGMP v3, UDP, HTTP, Telnet and, FTP.

11. The device of claim 1, wherein the output means is a display screen and the display screen is able to display the communication information, including text and video, that it receives.

12. The device of claim 11, wherein multiple communications devices are connected to the network, the network is a traffic control network and the multiple communications devices display traffic information that can be viewed by motorists.

13. The device of claim 11, wherein the display screen is able to display the communication information using different methods, including light emitting diodes (LED), liquid crystal display (LCD), and cathode ray tube (CRT).

14. The device of claim 12, wherein the display screen for each communications device is an electro-mechanical text board that displays large text messages for easy viewing by the motorists.
